(19) United States
(12) Patent Application Publication
(10) Pub. No.: US 2026/0323632 A1
(43) Pub. Date: Oct. 15, 2026

(54) METHODS AND APPARATUSES FOR SMALL DATA TRANSMISSION IN NON-TERRESTRIAL NETWORK

(71) Applicant: Lenovo (Beijing) Limited, Beijing (CN)

(72) Inventors: Min Xu, Beijing (CN); Ran Yue, Beijing (CN); Lianhai Wu, Beijing (CN); Jing Han, Beijing (CN); Jie Hu, Beijing (CN)

(73) Assignee: Lenovo (Beijing) Limited, Beijing (CN)

(21) Appl. No.: 18/998,754

(22) PCT Filed: Aug. 5, 2022
(86) PCT No.: PCT/CN2022/110560

§ 371 Date: Jan. 27, 2025

(51) Int. Cl. H04W 72/1268; H04W 56/00; H04W 84/06

(52) U.S. Cl. CPC H04W 72/1268; H04W 56/001; H04W 84/06

(57) ABSTRACT

The present application relates to methods and apparatuses for a small data transmission (SDT) in a non-terrestrial network (NTN). One embodiment of the present disclosure provides a user equipment (UE), comprising: a medium access control (MAC) entity; a radio resource control (RRC) entity; a transceiver; and a processor coupled with the transceiver and configured to: receive a configuration associated with an SDT in an NTN; and determine whether to initiate an SDT procedure based on the configuration

### TECHNICAL FIELD

The present disclosure relates to wireless communication, and particularly relates to methods and apparatuses for a small data transmission (SDT) in a non-terrestrial network (NTN).

### BACKGROUND OF THE INVENTION

A SDT procedure is a procedure that allows data and/or signalling transmission while the UE stays in an RRC_INACTIVE state (i.e. without transitioning to an RRC_CONNECTED state).

An NTN refers to a network, or segment of networks, which may use radio frequency (RF) resources on board a spaceborne vehicle or an airborne vehicle for transmission (e.g., a satellite). For example, the satellite in an NTN may be a geostationary Earth orbiting (GEO) satellite with a fixed location to the Earth, or a low Earth orbiting (LEO) satellite orbiting around the Earth.

During Rel-17, the NTN and the SDT were discussed and specified in parallel, NTN enhancements did not consider the cases with the SDT involved, and the SDT did not consider any potential issues when being applied in NTN scenarios. Accordingly, it is desirable to provide solutions for the issues when performing SDT in the NTN.

### SUMMARY

One embodiment of the present disclosure provides a user equipment (UE), comprising: a medium access control (MAC) entity; a radio resource control (RRC) entity; a transceiver; and a processor coupled with the transceiver and configured to: receive a configuration associated with an SDT in an NTN; and determine whether to initiate an SDT procedure based on the configuration.

In some embodiments, the configuration includes at least one of the following: an SDT terminate time threshold; a first validity time threshold associated with initiating the SDT procedure; or a first indication indicating whether an SDT data volume includes a volume of a timing advance report (TAR) medium access control (MAC) control element (CE) when comparing the SDT data volume with an SDT data volume threshold.

In some embodiments, the RRC entity is configured to send, to the MAC entity, a request for initiating the SDT procedure in response to at least one of the following conditions being fulfilled: a received SDT request being no later than the SDT terminate time threshold; or a valid duration of ephemeris data of a serving cell of the UE being longer than the first validity time threshold.

In some embodiments, the RRC entity is configured to indicate, to a MAC layer, at least one of the following: the SDT terminate time threshold; a stop serving time of the serving cell of the UE; a valid duration of ephemeris data of a serving cell of the UE and the first validity time threshold; or the first indication indicating whether the SDT data volume includes the volume of the TAR MAC CE.

In some embodiments, the SDT procedure is initiated in response to the MAC entity determining at least one of the following conditions being fulfilled: a received SDT request being no later than the SDT terminate time threshold; a valid duration of ephemeris data of the serving cell of the UE being longer than the first validity time threshold; or the SDT data volume and the volume of the TAR MAC CE being less than or equal to the SDT data volume threshold in the case that the first indication indicates the SDT data volume includes the volume of the TAR MAC CE; or the SDT data volume being less than or equal to the SDT data volume threshold in the case that the first indication indicates the SDT data volume does not include the volume of the TAR MAC CE.

In some embodiments, the RRC entity is configured to: receive, from the MAC entity, an indication of fulfilment; and determine to initiate the SDT procedure in response to at least one of the following conditions being fulfilled: a received SDT request being no later than the SDT terminate time threshold; or a valid duration of ephemeris data of a serving cell of the UE being longer than the first validity time threshold.

In some embodiments, the configuration includes a second validity time threshold associated with uplink timing alignment for the SDT procedure.

In some embodiments, the RRC entity is configured to: send, to a MAC entity, a third indication indicating starting a timer associated with configured grant (CG)-SDT time alignment in response to a valid duration of ephemeris data of a serving cell of the UE being longer than the second validity time threshold; or send, to a MAC entity, a fourth indication indicating stopping the timer associated with CG-SDT time alignment in response to the valid duration associated with ephemeris data of the serving cell of the UE being not longer than the second validity time threshold.

In some embodiments, the RRC entity is configured to indicate, to the MAC layer, the second validity time threshold and a valid duration of ephemeris data of a serving cell of the UE.

In some embodiments, the MAC entity is configured to perform timing alignment in response to: a valid duration of ephemeris data of a serving cell of the UE being longer than the second validity time threshold.

In some embodiments, the configuration includes one or more indications associated with an initiated SDT procedure, wherein the one or more indications include at least one of the following: an indication indicating ignoring a parameter associated with triggering a TAR; an indication indicating ignoring a parameter associated with triggering a TAR in the case that the initiated SDT procedure has no subsequent uplink transmission; an indication indicating precluding a TAR MAC CE in an initial UL transmission of the initiated SDT procedure; an indication indicating precluding the TAR MAC CE in a subsequent UL transmission of the initiated SDT procedure; an indication indicating including the TAR MAC CE in an initial UL transmission of the initiated SDT procedure; an indication indicating including the TAR MAC CE in a subsequent UL transmission of the initiated SDT procedure; an indication indicating ignoring triggering a scheduling request (SR) for the initiated SDT procedure; or an indication indicating suspending an uplink transmission of the initiated SDT procedure for acquiring valid ephemeris data of a serving cell of the UE.

In some embodiments, the RRC entity is further configured to: transmit, to the MAC entity, parameters associated with the one or more indications.

In some embodiments, the MAC entity is further configured to: ignore a parameter associated with triggering a TAR; ignore a parameter associated with triggering a TAR in a signalling in the case that the initiated SDT procedure has no subsequent uplink transmission; preclude the TAR MAC CE in an initial UL transmission of the initiated SDT procedure; preclude the TAR MAC CE in a subsequent UL transmission of the initiated SDT procedure; include the TAR MAC CE in an initial UL transmission of the initiated SDT procedure; include the TAR MAC CE in a subsequent UL transmission of the initiated SDT procedure; ignore triggering a scheduling request (SR) for the initiated SDT procedure; or suspend an uplink transmission of the initiated SDT procedure for acquiring valid ephemeris data of the serving cell of the UE.

Another embodiment of the present disclosure provides a base station (BS), comprising: a transceiver; and a processor coupled with the transceiver and configured to: transmit a configuration associated with an SDT in an NTN; and receive the SDT.

In some embodiments, the configuration includes at least one of the following: an SDT terminate time threshold; a first validity time threshold associated with initiating the SDT procedure; or a first indication indicating whether an SDT data volume includes a volume of a TAR MAC CE when comparing the SDT data volume with an SDT data volume threshold.

In some embodiments, the configuration includes a second validity time threshold associated with uplink timing alignment for the SDT procedure.

In some embodiments, the configuration includes one or more indications associated with an initiated SDT procedure, wherein the one or more indications include at least one of the following: an indication indicating ignoring a parameter associated with triggering a TAR; an indication indicating ignoring a parameter associated with triggering a TAR in the case that the initiated SDT procedure has no subsequent uplink transmission; an indication indicating precluding a TAR MAC CE in an initial UL transmission of the initiated SDT procedure; an indication indicating precluding the TAR MAC CE in a subsequent UL transmission of the initiated SDT procedure; an indication indicating including the TAR MAC CE in an initial UL transmission of the initiated SDT procedure; an indication indicating including the TAR MAC CE in a subsequent UL transmission of the initiated SDT procedure; an indication indicating ignoring triggering a scheduling request (SR) for the initiated SDT procedure; or an indication indicating suspending an uplink transmission of the initiated SDT procedure for acquiring valid ephemeris data of a serving cell of the UE.

Still another embodiment of the present disclosure provides a method performed by a UE, comprising: receiving a configuration associated with an SDT procedure in an NTN; and determining whether to initiate the SDT procedure based on the configuration.

Yet another embodiment of the present disclosure provides a method performed by a base station (BS), comprising: transmitting a configuration associated with an SDT procedure in an NTN; and receiving the SDT.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a flow chart of methods performed by a UE and a BS for an SDT in an NTN according to some embodiments of the present disclosure.

FIG. 3 illustrates a method performed by a UE for an SDT in an NTN according to some embodiments of the present disclosure.

FIG. 4 illustrates a method performed by a BS for an SDT in an NTN according to some embodiments of the present disclosure.

FIG. 5 illustrates a simplified block diagram of an apparatus for an SDT in an NTN according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under a specific network architecture(s) and new service scenarios, such as a cellular telephone network, a time division multiple access (TDMA)-based network, a code division multiple access (CDMA)-based network, an orthogonal frequency division multiple access (OFDMA)-based network, an LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates a schematic diagram of a wireless communication system 100 in accordance with some embodiments of the present application.

As shown in FIG. 1, the wireless communication system 100 includes two UEs, UE 101-A and UE 101-B, and a BS 102, for example, a satellite BS. Although merely one BS is illustrated in FIG. 1 for simplicity, it is contemplated that the wireless communication system 100 may include more BSs in some other embodiments of the present application. Similarly, although merely two UEs are illustrated in FIG. 1 for simplicity, it is contemplated that the wireless communication system 100 may include more UEs in some other embodiments of the present application.

The BS 102 may also be referred to as an access point, an access terminal, a base, a macro cell, a node-B, a radio access network (RAN) node, an enhanced node B (eNB), a gNB, a home node-B, a relay node, or a device, or described using other terminology used in the art. The BS 102 is generally part of a radio access network that may include a controller communicably coupled to the BS 102.

The UE 101-A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 101-A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101-A may include wearable devices, such as smart watches, fitness bands, optical head-mounted displays, or the like. Moreover, the UE 101-A may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The UEs, such as 101-A and UE 101-B may perform an SDT procedure. The SDT procedure is an SDT is enabled on a radio bearer basis and is initiated by the UE when the following conditions are fulfilled:
Less than a configured amount of uplink data awaits transmission across all radio bearers for which SDT is enabled;
The downlink (DL) reference signal receiving power (RSRP) is above a configured threshold; and
A valid SDT resource is available.

The present disclosure relates to two types of SDT procedures, which are: 1): a configured grant SDT, (CG-SDT), which is an SDT over type 1 CG resources configured via a dedicated signalling; and 2) a random access SDT (RA-SDT), which is an SDT over resources configured via system information.

Regarding the CG-SDT:
The CG resources for SDT are valid only within the cell where the UE received SDT configuration in dedicated signalling and transitioned to an RRC_INACTIVE state.
When using CG resources for initial SDT transmission, the UE may perform autonomous retransmission of the initial transmission if the UE does not receive confirmation from the network (dynamic UL grant or DL assignment) before a configured timer expires.
The network may schedule subsequent UL transmissions using dynamic grants or they can take place on the following CG resource occasions.
The DL transmissions may be scheduled using dynamic assignments.
The UE may initiate a subsequent UL transmission only after reception of the confirmation (dynamic UL grant or DL assignment) for the initial PUSCH (Physical Uplink Shared Channel) transmission from the network.
For a subsequent UL transmission, the UE may not initiate re-transmission over a CG resource.
An SDT procedure over CG resources may only be initiated with valid UL timing alignment.

Regarding the RA-SDT:
The network may configure 2-step RA resources, 4-step RA resources, or both for the RA-SDT.
The network may schedule subsequent UL and DL transmissions using dynamic UL grants and DL assignments, respectively, after the completion of the RA procedure.

Once initiated, the SDT procedure may be successfully completed after the UE is directed to an RRC_IDLE mode, an RRC_INACTIVE mode or an RRC_CONNECTED mode. In some other cases, the initiated SDT procedure cannot be successfully completed when one of the following occurs:
a cell reselection procedure;
expiry of the SDT failure detection timer;
a MAC entity of the UE reaching a configured maximum Physical Random Access Channel (PRACH) preamble transmission threshold
an RLC entity of the UE reaching a configured maximum retransmission threshold; or
expiry of SDT-specific timing alignment timer while the SDT procedure is ongoing over CG resources and the UE has not received a response from the network after the initial PUSCH transmission.

While the SDT procedure is ongoing, if data appears in a buffer of any radio bearer not enabled for SDT, the UE may initiate a transmission of a non-SDT data arrival indication using a message, such as a UEAssistanceInformation message, to the network and, if available, the message may include the resume cause.

For the SDT in an NTN, several issues may occur, for example, the present disclosure intends to solve some issues associated with the following aspects for a SDT in the NTN: 1) TAR; 2) stop serving time of an NTN; and 3) UL timing alignment based on valid ephemeris data.

### Issues Associated with TAR

In Rel-17 NR NTN, to help network in scheduling UL resources for the UE, a TAR was introduced to allow the UE to report its calculated TA in a MAC CE to the network. The UE may be triggered to transmit the TAR in the following occasions: 1) upon initiation of an RA procedure, e.g., for RRC establishment or resume, a TAR is triggered if a parameter, i.e. ta-Report, is configured as enabled in a system information block (such as SIB19); and 2) when the UE is in an RRC_CONNECTED mode, if the TA variation (i.e. the current TA compared with the TA included in the last TAR) is equal to or larger than a threshold, offsetThresholdTA, which may be configured via dedicated signalling, a TAR may also be triggered.

In some cases, if a TAR is triggered and there are no enough uplink shared control channel (UL-SCH) resources for transmitting the TAR, the UE may further trigger an SR if a parameter, i.e. TimingAdvanceSR is configured as enabled via dedicated signalling.

In an NTN cell, when a UE receives a system information block (such as SIB 19), in which the parameter, i.e. ta-Report, is enabled, and an SDT procedure may be triggered. For the CG-SDT, the UE may neither initiate an RA procedure nor transit to RRC_CONNECTED mode, therefore, no TAR will be triggered. For the RA-SDT, the RRC resume message (for example, MSG 3 in a 4-step RA procedure) is used to transmit the initial SDT data or signalling and an RA procedure is initiated. With the parameter, i.e. ta-Report in SIB19 being enabled, a TAR will be triggered.

For the above scenario, several issues regarding TAR may occur:

### Issue 1-1:

For an SDT procedure, there may be no need to trigger a TAR. The TAR is provided to the network for subsequent UL scheduling, in the case that there is no subsequent UL transmissions for an SDT procedure, which means the network may not perform subsequent UL scheduling, thus there may be no need to trigger a TAR. However, with the parameter ta-Report in SIB19 being enabled, a TAR may still be triggered, which may be unnecessary.

### Issue 1-2:

In the case that triggering a TAR is needed, the TAR may be transmitted with a TAR MAC CE, according to Rel-17 SDT, transmitting a MAC CE using SDT resources is not forbidden. That is, the TAR MAC CE may be transmitted with the SDT resources. However, the TAR is not that urgent because the network may schedule subsequent UL transmissions based on current UL timing without knowledge of the UE's TA. Further, a MAC CE may be prioritized over data, i.e. the transmission of the TAR MAC CE may be prioritized over the SDT transmission, and the TAR MAC CE may occupy the limited SDT resources.

Since the SDT resources are limited, it is unclear whether the TAR MAC CE can be transmitted using SDT resources for an initial UL transmission.

In the case that the TAR MAC CE is transmitted using SDT resources for the initial UL transmission, according to the requirements of the amount of uplink data of the SDT procedure, which should be no larger than a threshold, i.e. sdt-Data VolumeThreshold, it is unclear whether the volume of the TAR MAC CE should be counted as part of the UL data awaiting transmission, or should not be counted as part of the UL data awaiting transmission. In addition, it is unclear which one of the TAR MAC CE or the SDT initial UL data should be prioritized for the initial UL transmission.

### Issue 1-3:

In the case that the TAR MAC CE is not transmitted using SDT resources for the initial UL transmission, and is transmitted using SDT resources for a subsequent UL transmission, it is also unclear which one should be prioritized, i.e. the TAR MAC CE, or the subsequent UL transmission of the SDT transmission.

In conclusion, regarding the TAR, the issue may include whether to trigger a TAR for an SDT procedure, and how to handle a triggered TAR during the SDT procedure.

### Issues associated with stop serving time

In an NTN, the NTN cells may stop service at a certain moment, which may be referred to as: stop serving time. For example, there may be stop serving time for an NTN cell managed by a moving satellite (e.g., LEO satellite), when time passes the stop serving time, the cell managed by the moving satellite may vanish. For a quasi-earth-fixed cell, the satellite may form a steerable cell on Earth, the stop serving time may be cell-specific and may be broadcasted with a parameter, i.e. t-Service. For an Earth-moving cell, the cell may follow the satellite coverage, and move with the speed of the satellite, the stop serving time is UE-specific and may be estimated by the UE based on the location of the UE and the satellite ephemeris.

In some cases, in an NTN cell with stop serving time, an SDT procedure may be triggered near the stop serving time before it approaches, in other words, there may be not enough time for the SDT procedure.

For CG-SDT, the UE may need to transmit the SDT UL data at the scheduled timing and may receive SDT DL data afterwards, and this process needs a time duration of at least one round-trip time (RTT), which could be up to 500 ms in an NTN due to the large propagation delay via satellites. For the RA-SDT, more than one RTTs may be needed because the UE may need to additionally perform random access first.

When there is not much time left before the stop serving time (e.g. 1 or 2 RTTs before), triggering an SDT procedure may be unnecessary as it may not be completed in time. Moreover, according to Rel-17 NTN, at least for quasi-Earth-fixed cells, a cell reselection procedure should be triggered before the stop serving time of the NTN cell, e.g. t-Service. The cell reselection procedure may terminate an initiated SDT procedure, this will further limit the available time for an SDT procedure before the stop serving time.

In conclusion, regarding the stop serving time of an NTN cell, the issue may include an SDT procedure initiated near the stop serving time of the NTN cell may not be successfully completed in time, which is due to the stop serving time of an NTN cell as well as the mandatory cell reselection triggered before the stop serving time of an NTN cell.

### Issues associated with UL Timing Alignment Based on valid Ephemeris Data

In an NTN, the UE in an RRC-IDLE mode or an RRC_INACTIVE mode may need valid satellite ephemeris data to calculate the TA for UL timing alignment. The UE may attempt to re-acquire satellite ephemeris data in the system information block, i.e. SIB19, before the end of its valid duration (i.e. ntn-ULSync ValidityDuration starting at the time, i.e. epochTime) based on UE implementation.

In an NTN cell, valid satellite ephemeris data is necessary for UL timing alignment, and an SDT procedure may be triggered.

For the RA-SDT, although the RA-SDT does not require UL timing alignment, the UE in an NTN cell needs to acquire satellite ephemeris data for TA pre-compensation before initiating an RA procedure. As a result, for the RA-SDT, initiating an SDT procedure needs to wait for satellite ephemeris data acquisition anyway.

For the CG-SDT, UL timing alignment (i.e. TA validation) is partially determined in the MAC entity by a timer, cg-SDT-TimeAlignmentTimer, which is configured by network, and in an NTN, the validity of satellite ephemeris data may also have an impact on UL timing alignment. From network implementation's perspective, the serving BS may either consider ephemeris data validity duration or not when configuring cg-SDT-TimeAlignmentTimer, i.e., the expiration time of cg-SDT-TimeAlignmentTimer may be either earlier than the end of ephemeris data validity duration, or not earlier than the end of ephemeris data validity duration.

In the case that the network configures the timer, i.e. cg-SDT-TimeAlignmentTimer, not beyond ephemeris data validity duration, after successfully re-acquiring of ephemeris data, it is unclear whether UL timing alignment for the CG-SDT can be considered as valid or not.

In this case it may unnecessarily limit the usage of CG-SDT, as the UE may attempt to acquire new ephemeris data to keep a valid UL timing alignment, while the expiration of the timer, i.e. cg-SDT-TimeAlignmentTimer, could stop the UE from using CG-SDT.

In the case that the network configures the timer, i.e. cg-SDT-TimeAlignmentTimer beyond ephemeris data validity duration, when an SDT procedure is triggered near an attempt of re-acquiring ephemeris data, it is unclear how to handle the initiation of the SDT procedure or ongoing transmission of the SDT procedure.

When the UE attempts to re-acquire ephemeris data, which means that a UL timing alignment may not be guaranteed for a while, as the current ephemeris data could expire shortly and the UE needs to calculate a TA based on the new ephemeris received at the a broadcast cycle of the system information block, i.e. SIB19.

For an SDT procedure triggered near such an attempt, at least its initial transmission or the autonomous retransmission of the initial transmission may be suspended to wait while calculating the new TA. The subsequent UL transmission may not need to be suspended as the UE may receive a timing advance command (TAC) from network before the subsequent UL transmission.

In conclusion, in an NTN where the validity duration of ephemeris data has an impact on UL timing alignment, initiation or continuation of an SDT procedure may be interrupted by a UE's attempt to re-acquire ephemeris data and a subsequent calculation based on it.

The present disclosure proposes some solutions for solving the above issues.

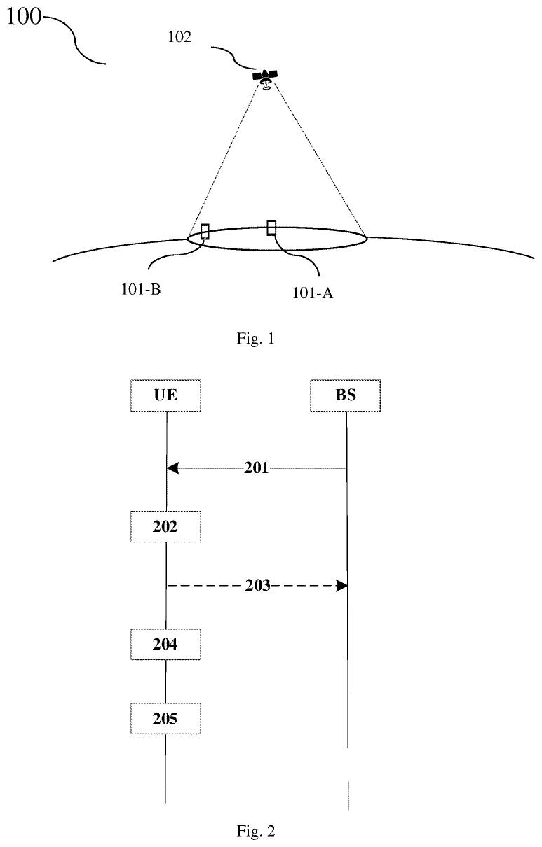

FIG. 2 illustrates a flow chart of methods performed by a UE and a BS for an SDT in an NTN according to some embodiments of the present disclosure.

In operation 201, the BS may transmit a configuration to the UE. The configuration may be associated with the SDT.

According to different information included in the configuration, several solutions are proposed as follows.

### Solution A

In some embodiments, the configuration include at least one of the following:
an SDT terminate time threshold;
a validity time threshold associated with initiating the SDT procedure; or
an indication indicating whether an SDT data volume includes a volume of a TAR MAC CE when comparing the SDT data volume with an SDT data volume threshold.

The SDT terminate time threshold may be represented as: t-SDT, which may be a time point before the stop serving time of the serving cell. The value of the SDT terminate time threshold may be based on the stop serving time of the serving cell.

In some embodiments, the service time, i.e. t-Service, may be broadcasted by an NTN quasi-Earth-fixed cell, or may be based on stop serving time of an NTN Earth-moving cell derived from the coverage information (including satellite ephemeris) and the location of the UE. In some other embodiments, the value of the SDT terminate time threshold may be based on UE's timing advance (TA) or RTT.

After receiving the above configuration, in operation 202, the UE may determine whether to initiate an SDT procedure based on the configuration.

In particular, upon receiving an SDT request from upper layers, the RRC entity, the MAC entity, or both, may perform the following options:

### Option A1:

The RRC entity may determine whether at least one of the following conditions for initiating SDT is fulfilled or not, and send, to the MAC entity, a request for initiating the SDT procedure in response to the fulfillment:
Condition A1: a received SDT request from upper layers being no later than the SDT terminate time threshold. That is, in the case that the RRC entity receives the SDT request from upper layers before the SDT terminate time threshold, i.e. t-SDT, or at the SDT terminate time threshold, condition A1 is fulfilled. The SDT terminate time threshold may be an absolute time, such as 15:00 13 Jun. 2022, UTC time, and if the RRC entity receives the SDT request from upper layers before 15:00 13 Jun. 2022, UTC time, or receives the SDT request from upper layers at 15:00 13 Jun. 2022, UTC time, condition A1 is fulfilled. The SDT terminate time threshold may be a relative time, or other forms of time.
Condition A2: a valid duration of ephemeris data of a serving cell of the UE being longer than the validity time threshold associated with initiating the SDT procedure. That is, the fulfillment of this condition may suggest that the ephemeris data of the serving cell of the UE may stay valid during the SDT procedure.

In the case that condition A2 is not fulfilled, that is, the valid duration of ephemeris data of the serving cell of the UE is not longer than the validity time threshold associated with initiating the SDT procedure, the RRC entity may suspend sending the SDT request to the MAC entity, and wait for valid ephemeris data being acquired. Alternatively, the RRC entity may trigger acquiring valid ephemeris data to fulfill condition A2.

After the UE successfully acquires valid ephemeris data of the serving cell of the UE, the RRC entity may resume the initiation of the SDT procedure.

### Option A2:

The RRC entity may indicate to the MAC entity at least one of the following, and let the MAC entity determine whether at least one conditions for initiating SDT is fulfilled or nor:
the SDT terminate time threshold;
a stop serving time of the serving cell of the UE;
a valid duration of ephemeris data of a serving cell of the UE and the validity time threshold associated with initiating the SDT procedure; or
the indication indicating whether the SDT data volume includes the volume of the TAR MAC CE.

In some embodiments, the SDT terminate time threshold may be an absolute time, such as 15:00 13 Jun. 2022, UTC time. In some other embodiments, the SDT terminate time threshold may be a relative time, such as a time period of 20 ms, with the ending time of the time period being the stop serving time of the serving cell of the UE. In this case, the RRC entity may indicate both the SDT terminate time threshold and the stop serving time of the serving cell of the UE to the MAC entity.

The indication may indicate the SDT data volume includes the volume of the TAR MAC CE, or indicate that the SDT data volume does not include the volume of the TAR MAC CE.

After receiving at least one of the above information from the RRC entity, the MAC entity may determine whether at least one of the following conditions is fulfilled:
Condition A1′: a received SDT request being no later than the SDT terminate time threshold. That is, in the case that the MAC entity receives the SDT request from the RRC entity before the SDT terminate time threshold, i.e. t-SDT, or at the SDT terminate time threshold, condition A1′ is fulfilled.
Condition A2: as described in option A1, whereby such details are omitted here.

In the case that condition A2 is not fulfilled, that is, the valid duration of ephemeris data of the serving cell of the UE is not longer than the validity time threshold associated with initiating the SDT procedure, the MAC entity may suspend the determination of condition A2, and wait for the valid ephemeris data being acquired to fulfill this condition.

After the UE successfully acquires valid ephemeris data of the serving cell of the UE, the MAC entity may resume the determination of condition A2.
Condition A3: the data volume of the pending UL data across all RBs configured for SDT plus the data volume of a triggered TAR MAC CE is less than or equal to the SDT data volume threshold, e.g. sdt-Data VolumeThreshold.

In the case that the indication indicates that the SDT data volume includes the volume of the TAR MAC CE, the MAC entity may compare the data volume of the pending UL data across all RBs configured for SDT (denoted as V_{SDT} for simplicity), and the data volume of a triggered TAR MAC CE (denoted as V_{TAR} for simplicity) with the SDT data volume threshold, e.g. sdt-Data VolumeThreshold (denoted as T_{SDT} for simplicity). In particular, the MAC entity may determine whether V_{SDT}+V_{TAR}≤T_{SDT}. In the case that V_{SDT}+V_{TAR}≤T_{SDT}, the MAC entity may determine that condition A3 is fulfilled; and in the case that V_{SDT}+V_{TAR}>T_{SDT}, the MAC entity may determine that condition A3 is not fulfilled.

In the case that the indication indicates that the SDT data volume does not include the volume of the TAR MAC CE, the MAC entity may compare the data volume of the pending UL data across all RBs configured for SDT (denoted as V_{SDT} for simplicity) with the SDT data volume threshold, e.g. sdt-Data VolumeThreshold (denoted as T_{SDT} for simplicity). In particular, the MAC entity may determine whether V_{SDT}≤TS_{DT}. In the case that V_{SDT}≤T_{SDT}, the MAC entity may determine that condition A3 is fulfilled; and in the case that V_{SDT}>T_{SDT}, the MAC entity may determine that condition A3 is not fulfilled.

After determining at least one the above conditions being fulfilled, the MAC entity may send an indication of fulfilment to RRC layer.

### Option A3:

In this option, the RRC entity may receive, from the MAC entity, an indication of fulfilment. The indication of fulfilment may indicate that the condition for initiating SDT of which the MAC entity is responsible for, is fulfilled. For example, the MAC entity may be responsible for determining whether condition A3 as described in option A2 is fulfilled.

The RRC entity may determine to initiate the SDT procedure in response to at least one of the following conditions being fulfilled:
Condition A1: as described in option A1, whereby such details are omitted here.
Condition A2: as described in option A1, whereby such details are omitted here.

In the case that condition A2 is not fulfilled, that is, the valid duration of ephemeris data of the serving cell of the UE is not longer than the validity time threshold associated with initiating the SDT procedure, the RRC entity may suspend sending the SDT request to the MAC entity, and wait while valid ephemeris data being acquired. Alternatively, the RRC entity may trigger acquiring valid ephemeris data to fulfill condition A2.

When at least one of the above conditions is fulfilled, the UE may initiate the SDT procedure, and in operation 203, the UE may transmit the SDT to the BS. In some embodiments, only when all the conditions in each option are fulfilled, may the UE initiate the SDT procedure. For example, in option A3, only when the RRC entity receives an indication of fulfilment from the MAC entity, and both condition A1 and condition A2 are fulfilled, may the UE initiate the SDT procedure.

### Solution B

In some other embodiments, the configuration may include a validity time threshold associated with uplink timing alignment for the SDT procedure.

After receiving the above configuration, in operation 204, the UE may determine how to handle the timer associated with CG-SDT time alignment. In particular, the RRC entity, the MAC entity, or both may take the following options:

### Option B1

The RRC entity may determine whether the following condition is fulfilled or not:
Condition B1: a valid duration of ephemeris data of a serving cell of the UE being longer than the validity time threshold associated with uplink timing alignment for the SDT procedure, and the validity time threshold is associated with uplink timing alignment for the SDT procedure.

In the case that condition B1 is fulfilled, the RRC entity may send, to the MAC entity, a third indication indicating starting (or restarting) a timer associated with CG-SDT time alignment, i.e. cg-SDT-TimeAlignmentTimer.

In the case that condition B1 is not fulfilled, the RRC entity may send, to the MAC entity, a fourth indication indicating stopping the timer associated with CG-SDT time alignment.

Furthermore, in the case that condition B1 is not fulfilled, that is, the valid duration of ephemeris data of the serving cell of the UE is not longer than the validity time threshold associated with uplink timing alignment for the SDT procedure, the RRC entity may suspend sending the SDT request to the MAC entity, and wait for valid ephemeris data being acquired. Alternatively, the RRC entity may trigger acquiring valid ephemeris data to fulfill condition B1.

### Option B2

The RRC entity may indicate, to the MAC entity, the validity time threshold associated with uplink timing alignment for the SDT procedure and a valid duration of ephemeris data of the serving cell of the UE, and let the MAC entity determine whether the above condition B1 is fulfilled or not.

Correspondingly, at the MAC entity side, the MAC entity may receive from the RRC entity, the validity time threshold associated with uplink timing alignment for the SDT procedure and a valid duration of ephemeris data of the serving cell of the UE. The MAC entity then determines whether the above condition B1 is fulfilled or not.

In the case that condition B1 is fulfilled, the MAC entity may start (or restart) a timer associated with CG-SDT time alignment, i.e. cg-SDT-TimeAlignmentTimer.

In the case that condition B1 is not fulfilled, the MAC entity may stop the timer associated with CG-SDT time alignment.

Furthermore, in the case that condition B1 is not fulfilled, that is, the valid duration of ephemeris data of the serving cell of the UE is not longer than the validity time threshold associated with uplink timing alignment for the SDT procedure, the RRC entity may suspend sending the SDT request to the MAC entity, and wait for valid ephemeris data being acquired. Alternatively, the RRC entity may trigger acquiring valid ephemeris data to fulfill condition B1.

When the UE has successfully acquired (or re-acquired) the ephemeris data of the serving cell of the UE (e.g., ntn-ULSyncValidityDuration is updated), the timer associated with CG-SDT time alignment, i.e. cg-SDT-TimeAlignmentTimer, may be started (or re-started).

In some embodiments, when acquiring (or re-acquiring) satellite ephemeris data of the serving cell of the UE, the UE may suspend initiation of an SDT procedure or an ongoing SDT procedure (initial SDT UL transmission or its autonomous retransmission) until successful reception and decoding of the satellite ephemeris data.

In some embodiments, the UE may determine whether to trigger acquiring (or re-acquiring) ephemeris data of the serving cell when an SDT request is received from upper layers, or when an SDT procedure is initiated. In particular, the determination may be based the remaining validity duration of the of the satellite ephemeris data (i.e. a valid duration of ephemeris data of a serving cell), and the UE's TA or RTT. The remaining validity duration of the of the satellite ephemeris data may be determined by the parameter: e.g. ntn-ULSync ValidityDuration.

For example, in the case the remaining validity duration of the of the satellite ephemeris data is shorter than the validity time threshold associated with uplink timing alignment for the SDT procedure, the UE may determine to trigger acquiring (or re-acquiring) ephemeris data of the serving cell.

### Solution C

In some other embodiments, the configuration may include one or more indications associated with an initiated SDT procedure, wherein the one or more indications include at least one of the following:
an indication indicating ignoring a parameter associated with triggering a TAR. The parameter may include the parameter, ta-Report, in a system information block, such as SIB19; the parameter may also include an offset threshold of TA, e.g. offsetThresholdTA, in a dedicated signalling, such as an RRC signaling. In other words, this indication indicates the UE not to trigger TAR for the initiated SDT procedure.
an indication indicating ignoring a parameter associated with triggering a TAR in the case that the initiated SDT procedure has no subsequent uplink transmission. The parameter may include the parameter, ta-Report, in a system information block, such as SIB19; the parameter may also include an offset threshold of TA, e.g. offsetThresholdTA, in a dedicated signalling, such as an RRC signaling. In other words, this indication indicates the UE not to trigger TAR for the initiated SDT procedure in the case that the initiated SDT procedure has no subsequent uplink transmission.
an indication from the RRC entity of the BS, which indicates ignoring the SDT procedure, i.e. not triggering the SDT procedure.
an indication indicating precluding a TAR MAC CE in an initial UL transmission of the initiated SDT procedure;
an indication indicating precluding the TAR MAC CE in a subsequent UL transmission of the initiated SDT procedure;
an indication indicating including the TAR MAC CE in an initial UL transmission of the initiated SDT procedure;
an indication indicating including the TAR MAC CE in a subsequent UL transmission of the initiated SDT procedure;
an indication indicating ignoring triggering an SR for the initiated SDT procedure. In other words, this indication indicates the UE not to trigger an SR for the initiated SDT procedure.
an indication indicating suspending an uplink transmission of the initiated SDT procedure for acquiring valid ephemeris data of the serving cell of the UE. The uplink transmission of the initiated SDT procedure may also include the autonomous retransmission.

After receiving the above one or more indications in the configuration from the BS, in operation 205, the RRC entity and the MAC entity may perform the following operations:

In some embodiments, the RRC entity may transfer the parameters of operations associated to the initiated SDT in the configuration to its MAC entity. For example, the parameters may include the above indication as well as the related parameters, such as the valid duration of the ephemeris data of a serving cell of the UE, or any other associated parameters.

In some embodiments, based on the above indications, the MAC entity may perform at least one of the following operations:
ignore a parameter associated with triggering a TAR. That is, the MAC entity may ignore the parameter ta-Report in SIB19, or the parameter offsetThresholdTA in dedicated signalling, or both. In other words, the MAC entity may not trigger TAR for this SDT procedure.
ignore a parameter associated with triggering a TAR in a signalling in the case that the initiated SDT procedure has no subsequent uplink transmission. That is, the MAC entity may ignore the parameter ta-Report in SIB19, or the parameter offsetThresholdTA in dedicated signalling, or both, in the case that the initiated SDT procedure has no subsequent uplink transmission. In other words, the MAC entity may not trigger TAR for this SDT procedure, in the case that the initiated SDT procedure has no subsequent uplink transmission.
preclude the TAR MAC CE in an initial UL transmission of the initiated SDT procedure.
preclude the TAR MAC CE in an subsequent UL transmission of the initiated SDT procedure;
include the TAR MAC CE in an initial UL transmission of the initiated SDT procedure;
include the TAR MAC CE in a subsequent UL transmission of the initiated SDT procedure;
ignore triggering an SR for the initiated SDT procedure; or
suspend an uplink transmission of the initiated SDT procedure for acquiring valid ephemeris data of the serving cell of the UE.

In some embodiments, when valid ephemeris data is acquired, the suspended uplink transmission of the initiated SDT procedure may be resumed.

In some embodiments, the indication may be from the RRC entity of the UE, which indicates the MAC entity to ignore the SDT procedure, i.e. not trigger the SDT procedure.

It should be noted that although operation 202, operation 204 and operation 205 are depicted separately, in some scenarios, these operations may be performed simultaneously.

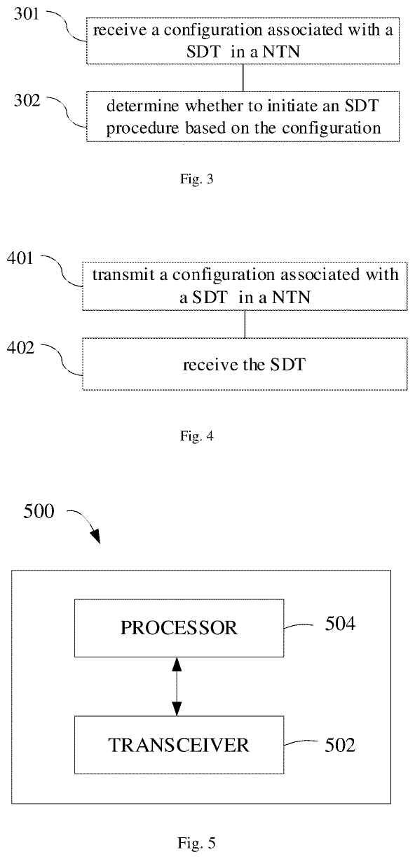

FIG. 3 illustrates a method performed by a UE for wireless communication according to some embodiments of the present disclosure.

In operation 301, the UE may receive a configuration associated with an SDT in an NTN; and in operation 302, determine whether to initiate an SDT procedure based on the configuration.

In some embodiments, the configuration includes at least one of the following: an SDT terminate time threshold; a first validity time threshold associated with initiating the SDT procedure; or a first indication indicating whether an SDT data volume includes a volume of a TAR MAC CE when comparing the SDT data volume with an SDT data volume threshold.

In some embodiments, the RRC entity is configured to send, to the MAC entity, a request for initiating the SDT procedure in response to at least one of the following conditions being fulfilled: a received SDT request being no later than the SDT terminate time threshold (i.e. condition A1 in option A1); or a valid duration of ephemeris data of a serving cell of the UE being longer than the first validity time threshold (i.e. condition A2 in option A1).

In some embodiments, the RRC entity is configured to indicate, to a MAC layer, at least one of the following: the SDT terminate time threshold; a stop serving time of the serving cell of the UE; a valid duration of ephemeris data of a serving cell of the UE and the first validity time threshold; or the first indication indicating whether the SDT data volume includes the volume of the TAR MAC CE. For example, the RRC entity may perform the operations as described in option A2.

In some embodiments, the SDT procedure is initiated in response to the MAC entity determining at least one of the following conditions being fulfilled: a received SDT request being no later than the SDT terminate time threshold (i.e. condition A1′); a valid duration of ephemeris data of the serving cell of the UE being longer than the first validity time threshold (i.e. condition A2); or the SDT data volume and the volume of the TAR MAC CE being less than or equal to the SDT data volume threshold in the case that the first indication indicates the SDT data volume includes the volume of the TAR MAC CE; or the SDT data volume being less than or equal to the SDT data volume threshold in the case that the first indication indicates the SDT data volume does not include the volume of the TAR MAC CE (i.e. condition A3).

In some embodiments, the RRC entity is configured to: receive, from the MAC entity, an indication of fulfilment; and determine to initiate the SDT procedure in response to at least one of the following conditions being fulfilled: a received SDT request being no later than the SDT terminate time threshold; or a valid duration of ephemeris data of a serving cell of the UE being longer than the first validity time threshold. For example, the RRC entity and the MAC entity perform the operations as described in option A3.

In some embodiments, the configuration includes a second validity time threshold associated with uplink timing alignment for the SDT procedure.

In some embodiments, the RRC entity is configured to: send, to a MAC entity, a third indication indicating starting a timer associated with CG-SDT time alignment in response to a valid duration of ephemeris data of a serving cell of the UE being longer than the second validity time threshold; or send, to a MAC entity, a fourth indication indicating stopping the timer associated with CG-SDT time alignment in response to the valid duration associated with ephemeris data of the serving cell of the UE being not longer than the second validity time threshold.

In some embodiments, the RRC entity is configured to indicate, to the MAC layer, the second validity time threshold and a valid duration of ephemeris data of a serving cell of the UE (i.e. solution B)

In some embodiments, the MAC entity is configured to perform timing alignment in response to: a valid duration of ephemeris data of a serving cell of the UE being longer than the second validity time threshold (i.e. condition B1).

In some embodiments, the configuration includes one or more indications associated with an initiated SDT procedure, wherein the one or more indications include at least one of the following: an indication indicating ignoring a parameter associated with triggering a TAR; an indication indicating ignoring a parameter associated with triggering a TAR in the case that the initiated SDT procedure has no subsequent uplink transmission; an indication indicating precluding a TAR MAC CE in an initial UL transmission of the initiated SDT procedure; an indication indicating precluding the TAR MAC CE in a subsequent UL transmission of the initiated SDT procedure; an indication indicating including the TAR MAC CE in an initial UL transmission of the initiated SDT procedure; an indication indicating including the TAR MAC CE in an subsequent UL transmission of the initiated SDT procedure; an indication indicating ignoring triggering an SR for the initiated SDT procedure; or an indication indicating suspending an uplink transmission of the initiated SDT procedure for acquiring valid ephemeris data of a serving cell of the UE.

In some embodiments, the RRC entity is further configured to: transmit, to the MAC entity, parameters associated with the one or more indications.

In some embodiments, the MAC entity is further configured to: ignore a parameter associated with triggering a TAR; ignore a parameter associated with triggering a TAR in a signalling in the case that the initiated SDT procedure has no subsequent uplink transmission; preclude the TAR MAC CE in an initial UL transmission of the initiated SDT procedure; preclude the TAR MAC CE in an subsequent UL transmission of the initiated SDT procedure; include the TAR MAC CE in an initial UL transmission of the initiated SDT procedure; include the TAR MAC CE in a subsequent UL transmission of the initiated SDT procedure; ignore triggering an SR for the initiated SDT procedure; or suspend an uplink transmission of the initiated SDT procedure for valid ephemeris data acquisition.

FIG. 4 illustrates a method performed by a BS for wireless communication according to some embodiments of the present disclosure.

In operation 401, the BS may transmit a configuration associated with an SDT in an NTN; and in operation 402, the BS may receive the SDT.

FIG. 5 illustrates a simplified block diagram of an apparatus according to some embodiments of the present disclosure.

As shown in FIG. 5, an example of the apparatus 500 may include at least one processor 504 and at least one transceiver 502 coupled to the processor 504. The apparatus 500 may be a UE, a BS, an access point, a satellite, an RAN node, or any other device with similar functions.

Although in this figure, elements such as the at least one transceiver 502 and processor 504 are described in the singular, the plural is contemplated unless a limitation to the singular is explicitly stated. In some embodiments of the present disclosure, the transceiver 502 may be divided into two devices, such as a receiving circuitry and a transmitting circuitry. In some embodiments of the present disclosure, the apparatus 500 may further include an input device, a memory, and/or other components.

In some embodiments of the present disclosure, the apparatus 500 may be a UE. The transceiver 502 and the processor 504 may interact with each other so as to perform the operations of the UE described in any of FIGS. 1-4. In some embodiments of the present disclosure, the apparatus 500 may be a node. The transceiver 502 and the processor 504 may interact with each other so as to perform the operations of the node described in any of FIGS. 1-4.

In some embodiments of the present disclosure, the apparatus 500 may further include at least one non-transitory computer-readable medium.

For example, in some embodiments of the present disclosure, the non-transitory computer-readable medium may have stored thereon computer-executable instructions to cause the processor 504 to implement the method with respect to the UE as described above. For example, the computer-executable instructions, when executed, cause the processor 504 interacting with transceiver 502 to perform the operations of the UE described in any of FIGS. 1-4.

In some embodiments of the present disclosure, the non-transitory computer-readable medium may have stored thereon computer-executable instructions to cause the processor 504 to implement the method with respect to the node as described above. For example, the computer-executable instructions, when executed, cause the processor 504 interacting with transceiver 502 to perform the operations of the node described in any of FIGS. 1-4.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a configuration associated with a small data transmission (SDT) in a non-terrestrial network (NTN); and
determine whether to initiate an SDT procedure based on the configuration.

2. The UE of claim 1, wherein the configuration includes at least one of:
an SDT terminate time threshold;
a first validity time threshold associated with initiating the SDT procedure; or
a first indication that indicates whether an SDT data volume includes a volume of a timing advance report (TAR) medium access control (MAC) control element (CE) when comparing the SDT data volume with a SDT data volume threshold.

3. The UE of claim 2, wherein an RRC entity of the UE is configured to send, to a MAC entity of the UE, a request for initiating the SDT procedure in response to at least one of one or more conditions being fulfilled, wherein the one or more conditions include:
a received SDT request being no later than the SDT terminate time threshold; or
a valid duration of ephemeris data of a serving cell of the UE being longer than the first validity time threshold.

4. The UE of claim 2, wherein an RRC entity of the UE is configured to indicate, to a MAC layer of the UE, at least one of:
the SDT terminate time threshold;
a stop serving time of a serving cell of the UE;
a valid duration of ephemeris data of the serving cell of the UE and the first validity time threshold; or
the first indication indicating whether the SDT data volume includes the volume of the TAR MAC CE.

5. The UE of claim 2, wherein the at least one processor is further configured to initiate the SDT procedure in response to a MAC entity of the UE determining at least one one or more conditions being fulfilled, wherein the one or more conditions include:
a received SDT request being no later than the SDT terminate time threshold;
a valid duration of ephemeris data of a serving cell of the UE being longer than the first validity time threshold;
the SDT data volume and the volume of the TAR MAC CE being less than or equal to the SDT data volume threshold in a case that the first indication indicates the SDT data volume includes the volume of the TAR MAC CE; or
the SDT data volume being less than or equal to the SDT data volume threshold in a case that the first indication indicates the SDT data volume does not include the volume of the TAR MAC CE.

6. The UE of claim 2, wherein an RRC entity of the UE is configured to:
receive, from a MAC entity of the UE, an indication of fulfilment; and
determine to initiate the SDT procedure in response to at least one of: one or more conditions being fulfilled, wherein the one or more conditions include:
a received SDT request being no later than the SDT terminate time threshold; or
a valid duration of ephemeris data of a serving cell of the UE being longer than the first validity time threshold.

7. The UE of claim 2, wherein the configuration includes a second validity time threshold associated with uplink timing alignment for the SDT procedure.

8. The UE of claim 7, wherein an RRC entity of the UE is configured to:
send, to a MAC entity of the UE, a third indication that indicates starting a timer associated with configured grant (CG)-SDT time alignment in response to a valid duration of ephemeris data of a serving cell of the UE being longer than the second validity time threshold; or
send, to a MAC entity, a fourth indication that indicates stopping the timer associated with CG-SDT time alignment in response to the valid duration associated with ephemeris data of the serving cell of the UE being not longer than the second validity time threshold.

9. The UE of claim 1, wherein the configuration includes one or more indications associated with an initiated SDT procedure, wherein the one or more indications include at least one of:
an indication that indicates ignoring a parameter associated with triggering a timing advance report (TAR);
an indication that indicates ignoring a parameter associated with triggering the TAR in a case that the initiated SDT procedure has no subsequent uplink (UL) transmission;
an indication that indicates precluding a TAR medium access control (MAC) control element (CE) in an initial UL transmission of the initiated SDT procedure;
an indication that indicates precluding the TAR MAC CE in a subsequent UL transmission of the initiated SDT procedure;
an indication that indicates including the TAR MAC CE in the initial UL transmission of the initiated SDT procedure;
an indication that indicates including the TAR MAC CE in a subsequent UL transmission of the initiated SDT procedure;
an indication that indicates ignoring triggering a scheduling request (SR) for the initiated SDT procedure; or
an indication that indicates suspending an UL transmission of the initiated SDT procedure for acquiring valid ephemeris data of a serving cell of the UE.

10. The UE of claim 9, wherein an RRC entity of the UE is further configured to:
transmit, to a MAC entity of the UE, parameters associated with the one or more indications.

11. The UE of claim 10, wherein the MAC entity is further configured to:
ignore a parameter associated with triggering the TAR;
ignore a parameter associated with triggering the TAR in a signaling in a case that the initiated SDT procedure has no subsequent UL transmission;
preclude the TAR MAC CE in the initial UL transmission of the initiated SDT procedure;
preclude the TAR MAC CE in the subsequent UL transmission of the initiated SDT procedure;
include the TAR MAC CE in the initial UL transmission of the initiated SDT procedure;
include the TAR MAC CE in the subsequent UL transmission of the initiated SDT procedure;
ignore triggering the SR for the initiated SDT procedure; or
suspend an UL transmission of the initiated SDT procedure for acquiring valid ephemeris data of the serving cell of the UE.

12. A base station (BS) for wireless communication, comprising:
at least one memory; and
at least one processor coupled with the at least one memory and configured to cause the base station to:
transmit a configuration associated with a small data transmission (SDT) in a non-terrestrial network (NTN); and
receive the SDT.

13. The BS of claim 12, wherein the configuration includes at least one of:
an SDT terminate time threshold;
a first validity time threshold associated with initiating an SDT procedure; or
a first indication that indicates whether a SDT data volume includes a volume of a timing advance report (TAR) medium access control (MAC) control element (CE) when comparing the SDT data volume with a SDT data volume threshold.

14. The BS of claim 12, wherein the configuration includes one or more indications associated with an initiated SDT procedure, wherein the one or more indications include at least one of:
an indication that indicates ignoring a parameter associated with triggering a timing advance report (TAR);
an indication that indicates ignoring a parameter associated with triggering the TAR in a case that the initiated SDT procedure has no subsequent uplink transmission;
an indication that indicates precluding a TAR medium access control (MAC) control element (CE) in an initial uplink (UL) transmission of the initiated SDT procedure;
an indication that indicates precluding the TAR MAC CE in a subsequent UL transmission of the initiated SDT procedure;
an indication that indicates including the TAR MAC CE in the initial UL transmission of the initiated SDT procedure;
an indication that indicates including the TAR MAC CE in a subsequent UL transmission of the initiated SDT procedure;
an indication that indicates ignoring triggering a scheduling request (SR) for the initiated SDT procedure; or
an indication that indicates suspending an UL transmission of the initiated SDT procedure for acquiring valid ephemeris data of a serving cell of a user equipment (UE).

15. A method performed by a user equipment (UE), the method comprising:
receiving a configuration associated with a small data transmission (SDT) procedure in a non-terrestrial network (NTN); and
determining whether to initiate the SDT procedure based on the configuration.

16. A processor for wireless communication, comprising:
at least one controller coupled with at least one memory and configured to cause the processor to:
receive a configuration associated with a small data transmission (SDT) in a non-terrestrial network (NTN); and
determine whether to initiate an SDT procedure based on the configuration.

17. The processor of claim 16, wherein the configuration includes at least one of:
an SDT terminate time threshold;
a first validity time threshold associated with initiating the SDT procedure; or
a first indication that indicates whether an SDT data volume includes a volume of a timing advance report (TAR) medium access control (MAC) control element (CE) when comparing the SDT data volume with a SDT data volume threshold.

18. The processor of claim 17, wherein an RRC entity of a user equipment (UE) that includes the processor is configured to send, to a MAC entity of the UE, a request for initiating the SDT procedure in response to at least one of one or more conditions being fulfilled, wherein the one or more conditions include:
a received SDT request being no later than the SDT terminate time threshold; or
a valid duration of ephemeris data of a serving cell of the UE being longer than the first validity time threshold.

19. The processor of claim 17, wherein an RRC entity of a user equipment (UE) that includes the processor is configured to indicate, to a MAC layer of the UE, at least one of:
the SDT terminate time threshold;
a stop serving time of a serving cell of the UE;
a valid duration of ephemeris data of the serving cell of the UE and the first validity time threshold; or
the first indication indicating whether the SDT data volume includes the volume of the TAR MAC CE.

20. The processor of claim 17, wherein an RRC entity of a user equipment (UE) that includes the processor is configured to:
receive, from a MAC entity of the UE, an indication of fulfilment; and
determine to initiate the SDT procedure in response to at least one of one or more conditions being fulfilled, wherein the one or more conditions include:
a received SDT request being no later than the SDT terminate time threshold; or
a valid duration of ephemeris data of a serving cell of the UE being longer than the first validity time threshold.
